(19) United States
(12) Patent Application Publication
(10) Pub. No.: US 2003/0128539 A1
(43) Pub. Date: Jul. 10, 2003

(54) Key holding device with illuminating function

(76) Inventor: Chang Jen Liu, Shulin city (TW)

Correspondence Address: RABIN & BERDO, P.C., Suite 500, 1101 14th Street, N.W., Washington, DC, 20005, US

(21) Appl. No.: 10/041,471

(22) Filed: Jan. 10, 2002

(51) Int. Cl. E05B 17/10; F21L 4/04

(52) U.S. Cl. 362/100; 362/200

(57) ABSTRACT

A key holding device with illuminating function includes a case having a pair of lengthwise guiding channels provided at two sides near a front end thereof for holding a U-ring thereto, so that a plurality of keys may be held on the U-ring. An illuminator lamp and a banknote test lamp are provided in the case at predetermined positions and could be turned on via depression of two push buttons on the case separately electrically connected to the two lamps. A slide switch is further provided on the case. When the slide switch is shifted to a side corresponding to the illuminator lamp, the illuminator lamp is kept turned on without the need of continuously depressing the push button corresponding to that lamp.

### FIELD OF THE INVENTION

The present invention relates to a key holding device with illuminating function. The key holding device includes a case having a U-ring connected thereto for holding increased number of keys, and having an illuminator lamp and a banknote test lamp to provide illuminating and banknote-testing functions.

### BACKGROUND OF THE INVENTION

Taiwanese Patent Application No. 83212429 entitled “Key Ring with Snap-on Retaining ring” discloses a key ring including a main body, a retaining ring, and a snap plate. The main body of the key ring is provided at one side with a receiving space, in a selected position of which a retaining bar is provided, and at an outer end of which two adjacent vertical cuts are provided. The snap plate has a rear end connected to a flexible strip, and a front end provided with a retaining groove. Two sidewalls of the retaining groove are slightly different in length. The shorter sidewall of the retaining groove has a bevel surface, allowing the push plate to implant into the receiving space of the main body with the flexible strip at the rear end of the snap plate firmly pressed against the main body. The retaining bar in the receiving space of the main body straddles the retaining groove on the snap plate to provide a stopper. The shorter sidewall of the retaining groove bears against the cut of the receiving space that faces toward the retaining ring of the key ring, such that the bevel surface of the shorter sidewall corresponds to the cut. The longer sidewall of the retaining groove extends beyond another cut, allowing the retaining ring to insert into the corresponding cut to engage with and be stopped by the bevel surface. When an end of the longer sidewall projected from the cut is pushed, the snap plate and the flexible strip retract to releases the retaining state.

A disadvantage of the above-described key ring is that there is only one retaining ring for holding only limited number of keys. Moreover, the key ring includes only one bulb that is powered with two batteries and turned on via a touch switch. Conditions of poor contact of the touch switch occur frequently.

It is therefore tried by the inventor to develop a key holding device with illuminating function, so that a U-ring is connected to the key holding device for holding increased number of keys, and two lamps, including an illuminator lamp and a banknote test lamp, are provided with the key holding device for the same to serve as an illuminator and a banknote tester.

### SUMMARY OF THE INVENTION

The present invention provides a key holding device having a case that is provided at two sides near a front end thereof with two lengthwise guiding channels for a U-ring to movably connect thereto to hold increased number of keys.

A primary object of the present invention is to provide an illuminator lamp in the case of the key holding device, and a push button on the case for controlling turning on and off of the illuminator lamp, so that a user may depress and hold the push button for the illuminator lamp to continuously project light, enabling the user to locate a keyhole or look for something in the dark.

Another object of the present invention is to provide a banknote test lamp in the case of the key holding device, and a push button on the case for controlling turning on and off of the banknote test lamp, so that a user may depress and hold the push button for the banknote test lamp to continuously project ultraviolet rays, enabling the user to test banknotes for any forgery thereof.

A further object of the present invention is to provide a slide switch on the case of the key holding device, so that the slide switch may be shifted to one of two sides to continuously turn on the illuminator lamp or the banknote test lamp without the need of depressing and holding any push button.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a key holding device with illuminating function according to the present invention;

FIG. 2 is an exploded perspective view of FIG. 1;

FIG. 3 shows a case of the key holding device of FIG. 1 in a horizontal position;

FIG. 4 shows a push button on the case of the key holding device of the present invention is depressed to turn on an illuminator lamp in the case;

FIG. 5 shows another push button on the case of the key holding device of the present invention is depressed to turn on a banknote test lamp in the case; and

FIG. 6 shows a slide switch on the case of the key holding device of the present invention is shifted to one side to shine the illuminator lamp continuously.

### DETAILED DESCRIPTION OF THE PREFERRED EMBODIMENTS

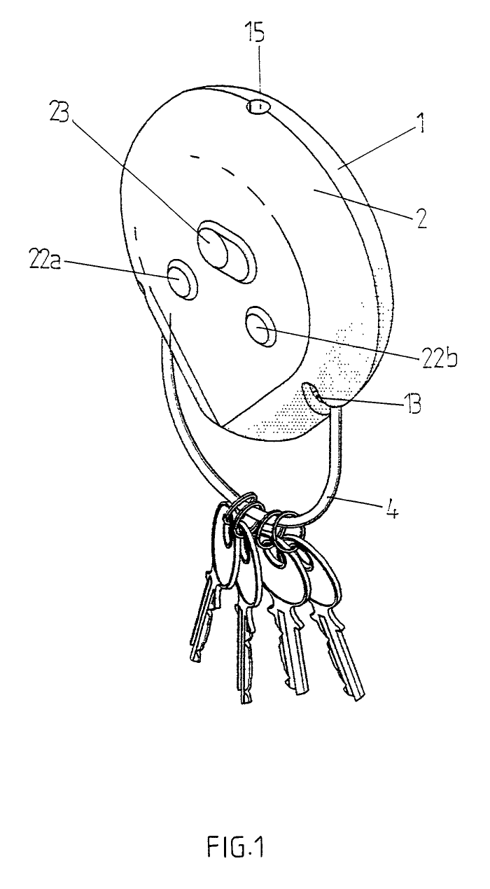

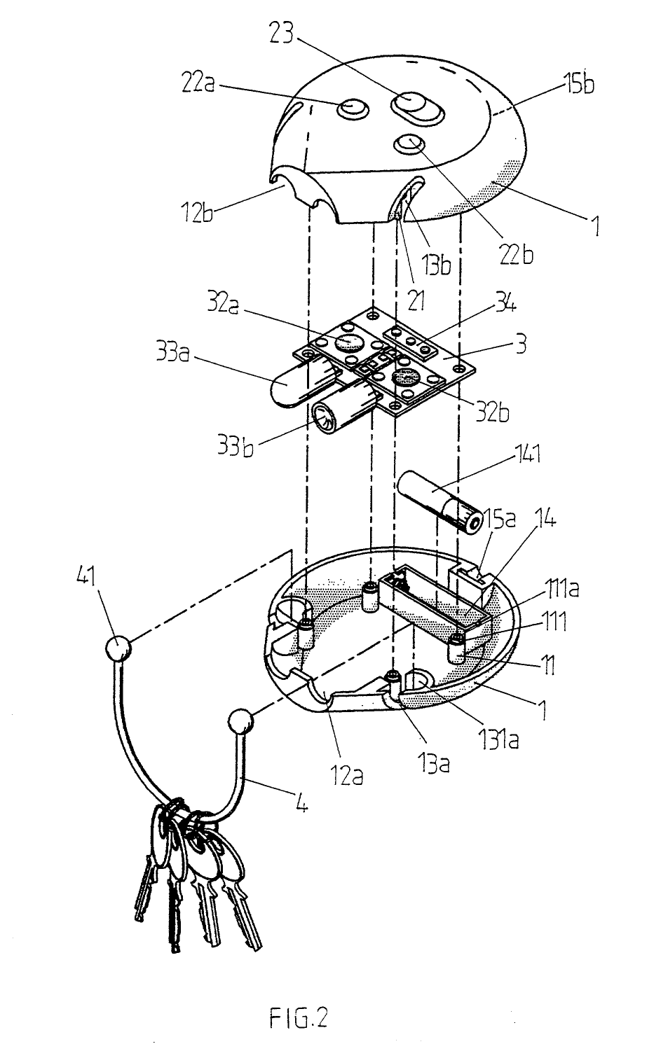

Please refer to FIGS. 1 and 2 that are assembled and exploded perspective views, respectively, of a key holding device with illuminating function according to the present invention. As shown, the key holding device mainly includes a case having a substantially drop-shaped profile and including a lower case 1 and an upper case 2.

The lower case 1 defines an open-topped inner space, in which four hollow bars 11 are vertically fixed to form four angles of a rectangle. Each of the hollow bars 11 defines an insertion hole 11a and has a boss 111 slightly projected from a top of the bar 11. A front end of the lower case 1 forms a flat end surface having two spaced and upward opened half-holes 12a. The lower case 1 is provided at two sidewalls near the front end with two lengthwise slots 13a, and at an inner end of each of the lengthwise slots with a semicircular cavity 131a to communicate with the slot 13a. The lower case 1 is also provided in the inner space close to a rear end with a transverse battery compartment 14 for accommodating a battery 141 therein, and at the rear end immediately behind the battery compartment 14 with an upward opened half-hole 15a.

A rectangular circuit board 3 is supported on the bars 11 by engaging mounting holes 31 provided at four corners of the circuit board 3 with the bosses 111 on the four bars 11 in the lower case 1. Power is supplied from the battery 141 in the compartment 14 to the circuit board 3. A first and a second touch switch 32a, 32b are provided on the circuit board 3 to respectively connect to two lamps 33a and 33b that are mounted to a front edge of the circuit board 3. Whereby when the circuit board 3 is supported on the four bars 11 in the lower case 1, the lamps 33a, 33b are separately horizontally laid in the two half-holes 12a at the front end of the lower case 1. A third touch switch 34 is further transversely provided at a rear end of the circuit board 3 to electrically connect to the lamp 33a. In the illustrated present invention, the lamp 33a is an illuminator lamp adapted to project bright light for indication and/or illumination; and the other lamp 33b is a banknote test lamp adapted to project ultraviolet rays for testing a banknote for any forgery thereof.

The upper case 2 is configured to mate with and assemble to the lower case 1. More particularly, the upper case 2 defines an open-bottomed inner space, in which four pins 21 are vertically fixed corresponding to the four bars 11 of the lower case 1 for tightly inserted into the insertion holes 111a and thereby connect the upper and the lower case together. The upper case 2 is also provided at a flat front end with two half-holes 12b corresponding to the two half-holes 12a on the lower case 1, such that when the upper case 2 is assembled to the lower case 1, the half-holes 12a and the half-holes 12b together form two through holes 12, within which the two lamps 33a and 33b are laid. Moreover, the upper case 2 is also provided at two sidewalls near the front end with two lengthwise slots 13b corresponding to the two lengthwise slots 13a on the lower case 1, and at an inner end of each of the lengthwise slots 13b with a semicircular cavity 131b to communicate with the lengthwise slot 13b. Each pair of the lengthwise slots 13a and 13b together forms a guide channel 13 after the upper case 2 is assembled to the lower case 1. A U-ring 4 is held to the case of the key holding device by setting two ball ends 41 thereof in two semicircular cavity pairs 131a and 131b. Since the ball ends 41 of the U-ring 4 have an outer diameter larger than a width of the guiding channels 13, it is impossible to directly remove the ball ends 41 out of the case via the guiding channels 13 after the lower and the upper case 1 and 2 are assembled together. That is, the U-ring 4 is limited to move along and within the guiding channels 13. A plurality of keys may be held on the U-ring 4. The number of U-rings 4 set in the guiding channels 13 may be increased or decreased depending on actual need.

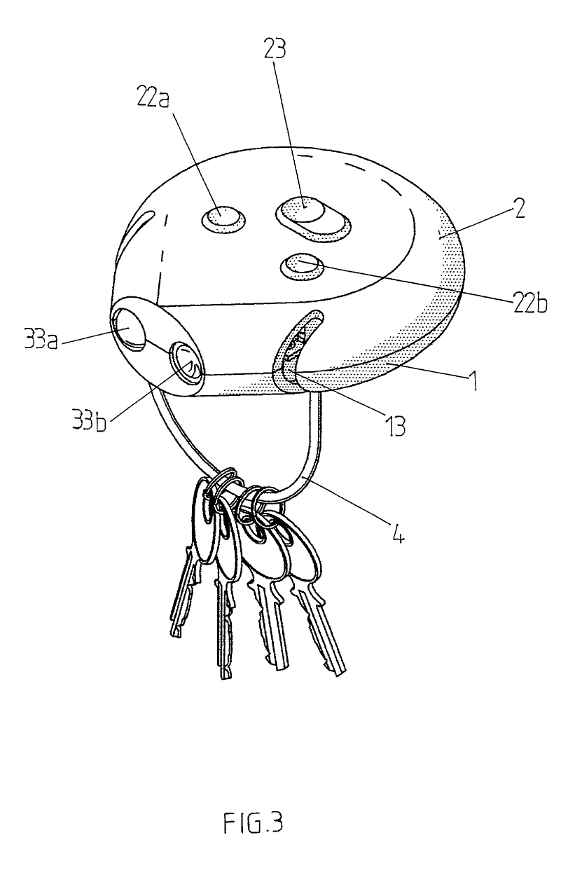

Please refer to FIG. 3 that is a perspective view showing the case of the key holding device of the present invention is in a horizontal position with the U-ring 4 depended from the guiding channels 13 formed from the lengthwise slots 13a and 13b. Either the lower case 1 or the upper case 2 may be located to face upward when the case of the key holding device is in the horizontal position. With the case in this horizontal position, the ball ends 41 of the U-ring 4 automatically slide into the two half cavities 131a or 131b, depending on which case 1 or 2 is facing downward. As can be seen in FIG. 2, there is also a half-hole 15b provided at a rear end of the upper case 2 corresponding to the half-hole 15a on the lower case 1. When the upper case 2 is assembled to the lower case 1, the two half-holes 15b and 15a together form a hole 15, as shown in FIG. 1. When a user wants to replace any internal component of the lamps 33a or 33b, or to increase or decrease the number of U-rings 4 held to the case of the key holding device, he or she may extend any thing having a pointed end into the hole 15 to repeatedly move up and down therein, so as to force the pins 21 out of the insertion holes 111a and separate the upper case 2 from the lower case 1.

The upper case 2 is provided at a top portion with first and second push buttons 22a and 22b corresponding to the first and the second touch switches 32a and 32b, respectively; and with a slide switch 23 corresponding to the third touch switch 34 on the circuit board 3 mounted in the lower case 1. When the circuit board 3 is supported on the bars 11 of the lower case 1 and the upper case 2 is assembled to the lower case 1, the push buttons 22a, 22b and the slide switch 23 are aligned with and located above the first, the second, and the third touch switches, respectively.

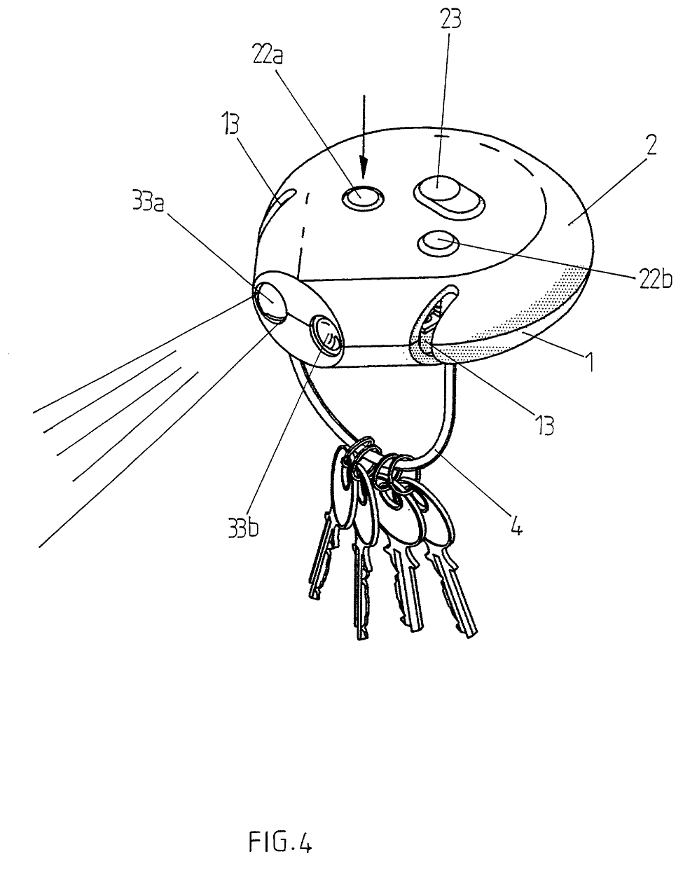

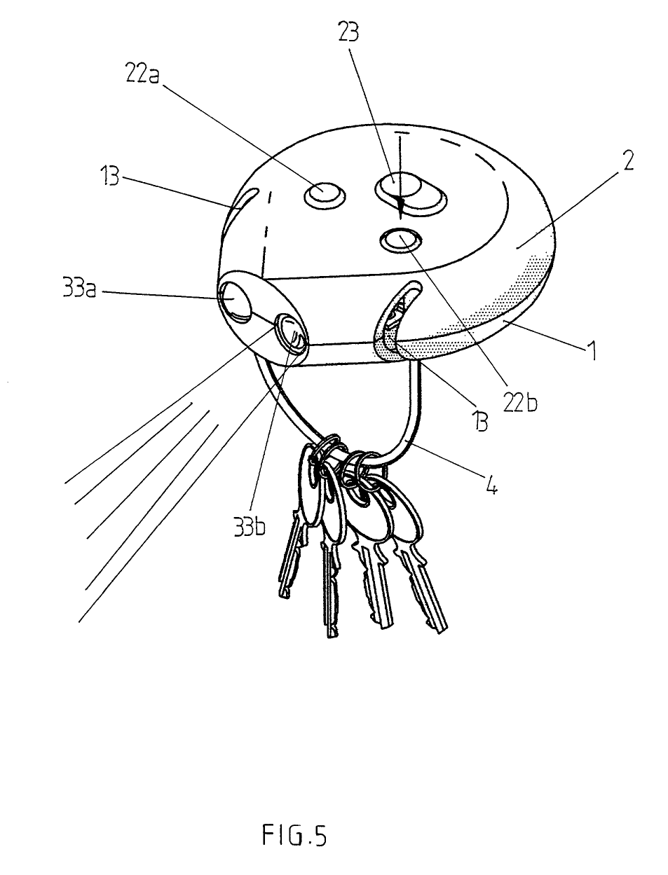

Please refer to FIG. 4. When the first push button 22a is depressed and held to this position, it contacts with the first touch switch 32a and thereby turns on the illuminator lamp 33a for the latter to project bright light that facilitates a user to locate a keyhole or look for something else in the dark. When the first push button 22a is released, the illuminator lamp 33a is immediately turned off. On the other hand, when the second push button 22b is held to a depressed position, as shown in FIG. 5, it contacts with the second touch switch 32b and thereby turns on the banknote test lamp 33b for the latter to project ultraviolet rays that facilitate the user to test banknotes for any forgery thereof. Similarly, when the second push button is released, the ultraviolet rays are immediately cutoff.

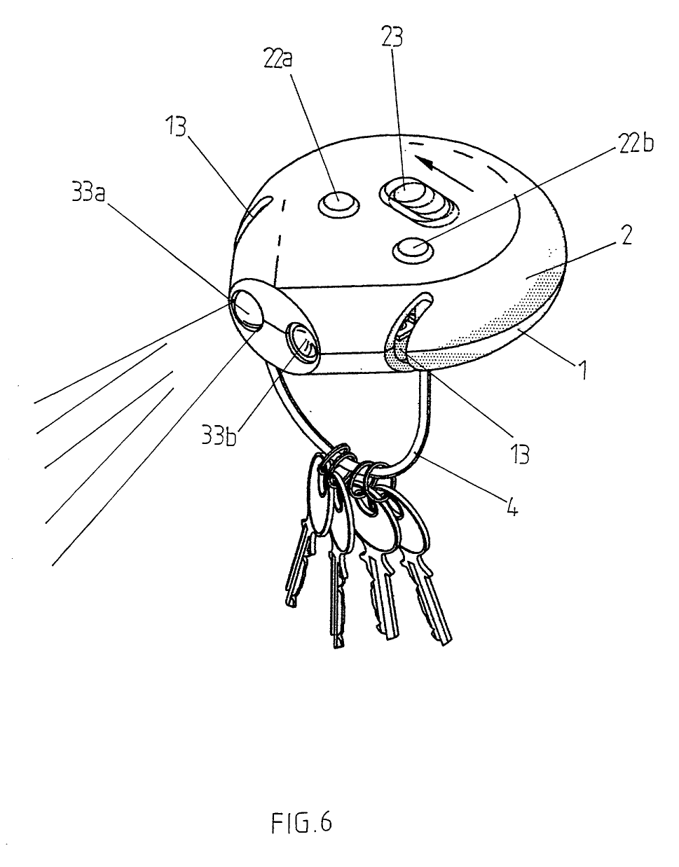

Please refer to FIG. 6. It would be inconvenient for a user to hold the first push button 22a to the depressed position to turn on the illuminator lamp 33a while opens, for example, a locked door or looks for something in the dark. In this case, the user may simply shift the slide switch 23 to one side corresponding to the illuminator lamp 33a to contact with the third touch switch 34, and the illuminator lamp 33a is kept turned on as long as need. Of course, it is also possible for both lamps 33a, 33b to be the illuminator lamps to provide brighter lights.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A key holding device with illuminating function, comprising a case that defines an inner space for accommodating a circuit board and a battery supplying power to said circuit board; and said case being provided at predetermined positions with a first push button and an illuminator lamp that are electrically connected to circuits on said circuit board, and at a peripheral edge with at least a pair of lengthwise guiding channels for a U-ring to movably connect thereto for holding a plurality of keys; whereby when said first push button is depressed and held to this position, said illuminator lamp is turned on to project bright light.

2. The key holding device with illuminating function as claimed in claim 1, wherein said case is further provided with a second push button and a banknote test lamp that are also electrically connected to circuits on said circuit board, whereby when said second push button is depressed and held to this position, said banknote test lamp is turned on to project ultraviolet rays.

3. The key holding device with illuminating function as claimed in claim 1, wherein said case is further provided with a slide switch electrically connected to circuits on said circuit board, whereby when said slide switch is shifted to one side corresponding to said first push button, said illuminator lamp is kept turned on.

4. The key holding device with illuminating function as claimed in claim 2, wherein said case is further provided with a slide switch electrically connected to circuits on said circuit board, whereby when said slide switch is shifted to one side corresponding to said first push button, said illuminator lamp is kept turned on.
